(19) United States
(12) Patent Application Publication
(10) Pub. No.: US 2014/0047159 A1
(43) Pub. Date: Feb. 13, 2014

(54) ENTERPRISE SERVER WITH FLASH STORAGE MODULES

(71) Applicants: Tony Ahwal, Santa Clara, CA (US); Yong Peng, Milpitas, CA (US); Rajeev Nagabhirava, Santa Clara, CA (US)

(72) Inventors: Tony Ahwal, Santa Clara, CA (US); Yong Peng, Milpitas, CA (US); Rajeev Nagabhirava, Santa Clara, CA (US)

(73) Assignee: SANDISK TECHNOLOGIES INC., Plano, TX (US)

(21) Appl. No.: 13/572,305

(22) Filed: Aug. 10, 2012

(51) Int. Cl. G06F 12/02

(52) U.S. Cl. 711/103; 711/E12.008

(57) ABSTRACT

A server system, such as an enterprise server, may include an array of memory devices. The memory devices may include non-volatile or flash memory and be referred to as flash storage modules (“FSM”). The server system includes a host computer or host server that communicates with the array of FSM. The host may include a media management layer or flash transformation layer that is implemented by drivers on the host for controlling the FSM.

### TECHNICAL FIELD

This application relates generally to flash memory devices in an enterprise server system. More specifically, this application relates to the control of flash storage modules through a media management layer at the host of the server system.

### BACKGROUND

Non-volatile memory systems, such as flash memory, have been widely adopted for use in consumer products. Flash memory may be found in different forms, for example in the form of a portable memory card that can be carried between host devices or as a solid state disk (SSD) embedded in a host device. Flash memory may be utilized as the storage mechanism within a server system, such as an enterprise server system. The server system may include an array of flash memory devices, but has an increase in complexity due to the complexity of the flash management controller for individual devices. The flash memory devices may generally be designed for small capacity usage, like a mobile or hybrid drive rather than as part of an array on a large scale server system. A strong embedded flash management controller is typically required for connections with a flash memory device. A media management layer (“MML”) or flash transformation layer (“FTL”) may be integrated in the device's controller and it may handle flash errors and interfacing with the host.

### SUMMARY

A server system, such as an enterprise server, may include an array of memory devices that include non-volatile or flash memory. Flash storage modules (“FSM”) may be modified flash memory devices that include a bridge and NAND memory, but does not include a management layer. In other words, the functionality of the management layer may be removed from the FSM and may be performed by the host. The server system includes a host computer or host server that communicates with the array of FSM. The host may include a management layer, which may be referred to as a media management layer (“MML”) or flash transformation layer (“FTL”). The MML is implemented by drivers on the host for controlling the FSM individually or as a group. Management functions of the FSM that were previously stored in the individual flash devices may be moved to the host for a centralized control of multiple modules. For example, mapping may be performed at the host rather than on the individual controllers for the memory devices. The centralized design of FSM control may provide cost and power savings, while improving performance.

According to a first aspect, a server system includes a host server with a media management layer and an array of flash storage modules that are managed by the host server through the media management layer. Each of the flash storage modules include a bridge for communicating with the host server and one or more NAND memory devices.

According to a second aspect, a server system includes a host in communication with an array of flash memory devices. The flash memory devices include a non-volatile storage having an array of memory blocks storing data and a controller in communication with the non-volatile storage. The controller is configured to perform low level operations for reading and writing data to the non-volatile storage. The host includes a memory management layer that is configured to manage the array of flash memory devices.

According to a third aspect, an enterprise memory system includes a host server computer that controls the enterprise memory system and an array of flash storage modules controlled by the host server computer. Each of the array of flash storage modules comprise a non-volatile storage having an array of memory blocks storing data and a bridge that interfaces the host server computer with the non-volatile storage and provides low-level controls for the non-volatile storage.

### BRIEF DESCRIPTION OF THE DRAWINGS

FIG. 1 is a block diagram of an array of flash storage modules connected with a host;

FIG. 2 is a block diagram of a host connected with flash storage modules;

FIG. 3 is a block diagram of a host connected with a memory system having non-volatile memory; and

FIG. 4 is a diagram illustrating operations performed by the host.

### BRIEF DESCRIPTION OF THE PRESENTLY PREFERRED EMBODIMENTS

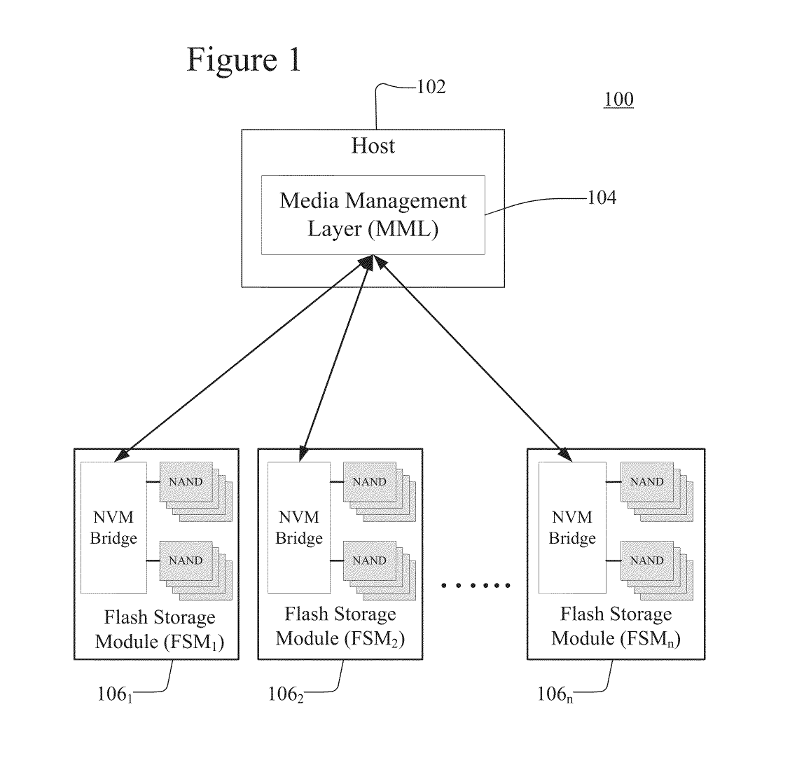

FIG. 1 is a block diagram of an array of flash storage modules connected with a host. In one embodiment, FIG. 1 illustrates an exemplary Enterprise Server system 100 in which a host 102 communicates with an array of memory, such as the array of flash storage modules (“FSM”) 106₁₋ₙ. The FSM shown in FIG. 1 may be non-volatile memory that is at least partially controlled by the host 102, while maintaining certain low level operations as part of the module. Accordingly, the FSM may be a smaller and faster component than other flash memory device because the host 102 manages many operations on behalf of the flash memory rather than utilizing a flash controller as part of the device that would otherwise perform those operations. In particular, the FSM may not have a memory management layer and the associated functionality.

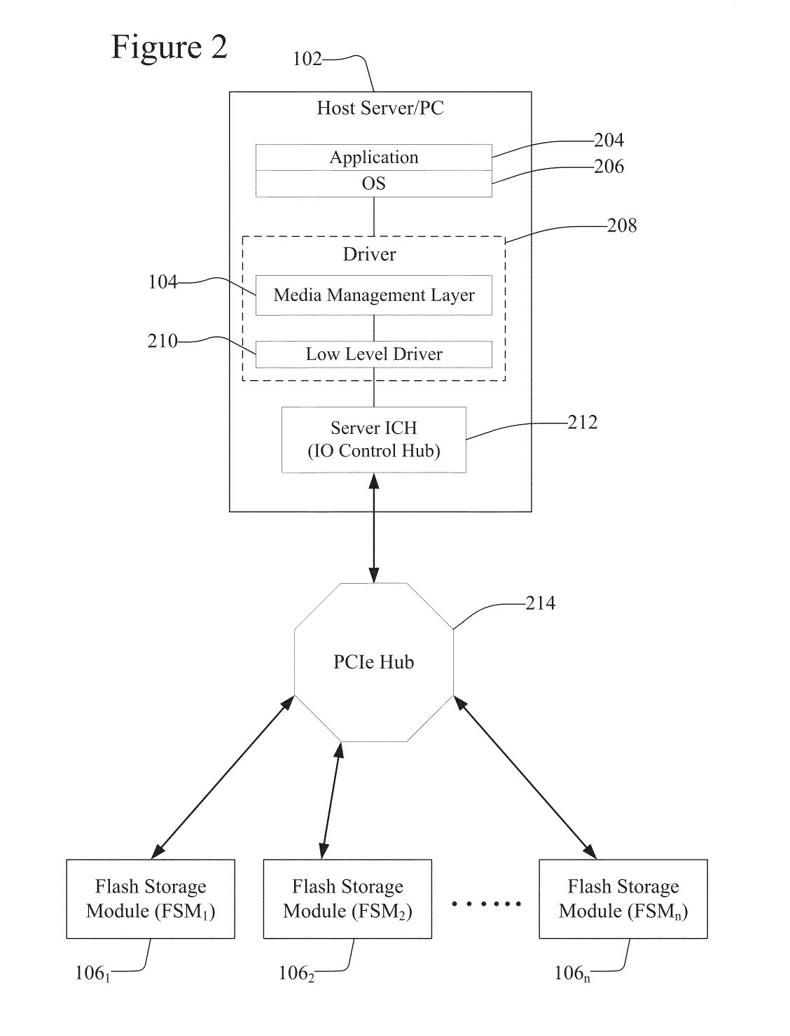

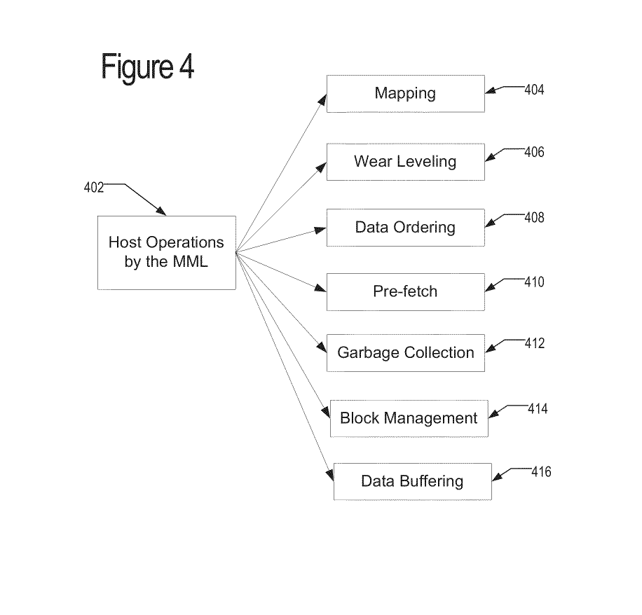

The server system's 100 host 102 may also be referred to as a host server or an enterprise server. The host 102 may include functionality (hardware and/or software) for serving requests to other programs, which may be referred to as clients. In one embodiment, the host 102 may be a physical computer or hardware system that provides a service for or with its clients. In the server system 100, the clients are the FSMs 106₁₋ₙ. The host 102 provides operations for the FSMs 106₁₋ₙ, including flash memory operations, such as those illustrated in FIG. 4 and described below with respect to FIG. 2. The host 102 may be directly connected with the FSMs 106₁₋ₙ, or may be connected through one or more networks. FIG. 2 illustrates an exemplary connection from the host utilizing a Peripheral Component Interconnect Express (“PCIe”) hub, which is further described below. Other connections between the host 102 and the FSMs 106₁₋ₙ are possible. In one embodiment, PCIe may be utilized because of performance and scalability. In other words, multiple devices may be combined together (scalable) for a bigger capacity. Interfaces other than PCIe may be utilized when scalable.

The host 102 includes a media management layer (“MML”) 104 that is implemented by drivers on the host 102 for controlling the FSMs 106₁₋ₙ individually or as a group. In alternative embodiments, the MML 104 may be referred to as a flash transformation/translation layer (“FTL”) or flash management module and may include controls or instructions for certain operations of the FSMs 106₁₋ₙ. The MML 104 may be responsible for the internals of NAND management, including the functions illustrated in FIG. 4. Exemplary management functions controlled by the MML 104 are described below with respect to FIGS. 2 and 4. In particular, FIG. 4 illustrates exemplary management functions or controls of the FSMs 106₁₋ₙ that may have been previously executed by a controller on a flash memory device, but were moved from the FSMs to the host 102 for a centralized control of those operations. In other words, the FSMs no longer have a MML because it is moved to the host.

Each of the FSMs 106₁₋ₙ may include a non-volatile memory (“NVM”) bridge that communicates with the host, either directly or through a hub as described with respect to FIG. 2. The FSMs 106₁₋ₙ further include one or more NAND flash memory blocks. Accordingly, each FSM may include the NVM bridge which acts as an interface between the host 102 and the NAND flash memory. The NVM bridge may have an on-chip redundant array of independent disks (“RAID”) feature for establishing connections for multiple disk drive components into a logical unit. The NVM bridge may have multiple channels that interface multiple devices. In one embodiment, the NVM bridge may include a controller or CPU with some control logic and two independent NAND memory control channels, as well as on board memory. For example, it may have RAM and may have ROM that allows it to make the basic booting and then it pulls the firmware to drive from the NAND. The NVM bridge may have a sequencer and address controllers for the NAND, as well as data and other controls for the NAND(s). The NVM bridge may interface with the NAND(s) on one end, with a PCI on the other end. In alternative embodiments, the communication may work with other communication interfaces and PCI is merely exemplary. There may be a controller and/or hardware logic that translates data into the PCI. There may also be functionality for checking certain data in real time. Other functions may be performed by the MML 104 in the host 102 rather than within the FSM 106. In one embodiment, the FSM 106 may maintain the following exemplary activities: flash page write/read/erase, error correction code (“ECC”), RAID, data encryption, flash error detection/handling, and/or data integrity protection.

The FSMs 106 may be stacked or combined to provide a bigger capacity. For example, the enterprise server system may increase the number of FSMs 106 to increase the memory capacity. Because of the modular nature of the FSMs 106, bad FSMs may easily be replaced, which improves maintenance of the server system. In addition, the power profile of the server system 100 may be improved by limiting the logic and CPUs running on the device. In particular, the controllers on the flash memory are limited since their operations are moved to the host 102, which results in less power usage by the flash memory.

FIG. 2 is a block diagram of the host 102 connected with flash storage modules (“FSMs”) 106₁₋ₙ. In one embodiment, FIG. 2 illustrates an alternative view of the server system 100 shown in FIG. 1. The host 102 may include an application layer 204 and an operating system (“OS”) 206. The application layer 204 may include software for controlling the host 102 and/or for interfacing with the FSMs 106. The host 102 may be a personal computer (“PC”) or other computing device that runs some form of an OS 206.

The host 102 includes drivers 208. One exemplary driver is a low level driver 210 that controls low level operations of the host 102. The low level driver 210 may be below the OS 206 and may help reorder the data and the information for optimizing access. The MML 104 is another example of a driver 208. As discussed above, the MML may include flash management operations that are executed by the host 102 rather than being executed by a controller on the flash memory devices. There may be a server I/O control hub (“ICH”) 212 that interfaces with the FSMs 106. The ICH 212 may be used to connect and control peripheral devices, such as the FSMs 106.

As shown in FIG. 2, there may be a Peripheral Component Interconnect Express (“PCIe”) hub 214 that communicates with the FSMs 106. In one embodiment, the PCIe hub 214 may communicate with the NVM bridge for each of the FSMs 106. PCIe is merely one example of a communication interface that may be used for the communications between the host 102 and the FSMs 106. Other bus standards may also be used. In one embodiment, the bus standard may be scalable, such that a plurality of devices may be utilized (e.g. FSMs). PCIe may include higher maximum system bus throughput, lower I/O pin count and smaller physical footprint that other bus standards, which improves performance. In one embodiment, the communications may be based on the Conventional PCI specifications and utilize PCIe 3.0. However, alternative (e.g. newer) communication interfaces may also be used. The hub 214 may be any hub controller, and a PCIe hub is merely exemplary. The PCI communications may include multiple lanes (e.g. up to 16 lanes) and each lane may correspond to an individual NAND from each of the FSMs 106.

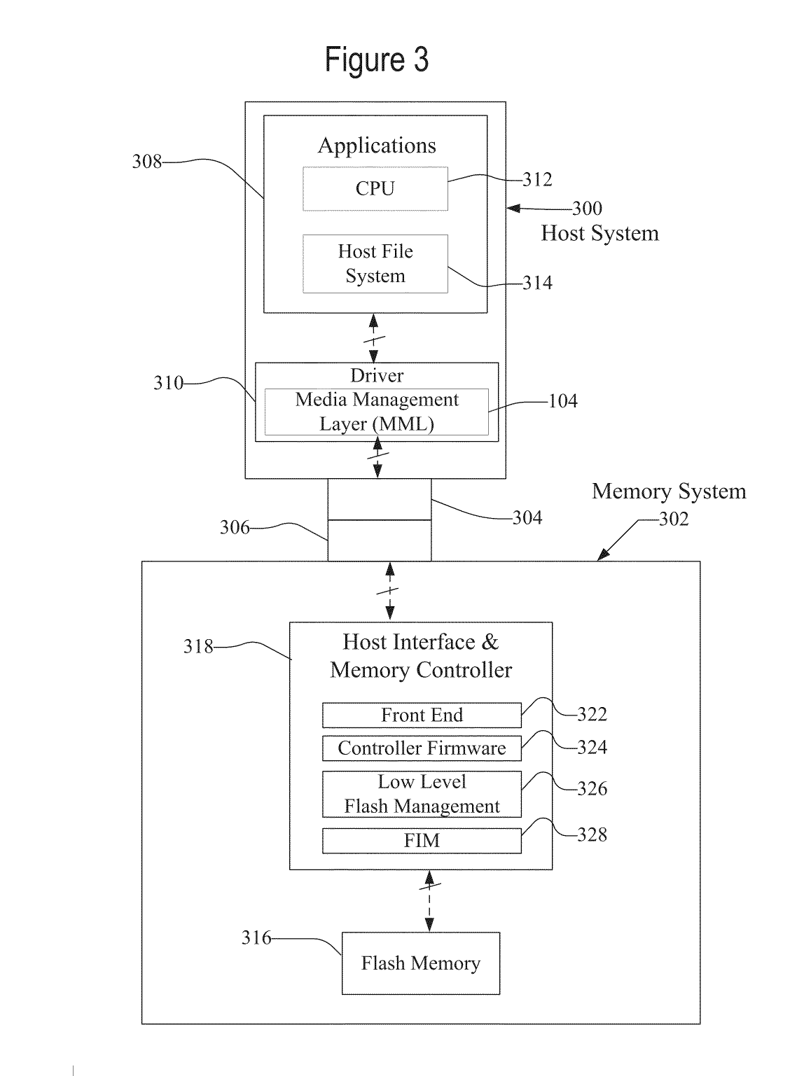

FIG. 3 is a block diagram of a host connected with a memory system having non-volatile memory. In particular, FIG. 3 illustrates a host system 300 (which may be one example of the host 102) and a memory system 302 (which may be one example of the FSM 106). The host system 300 of FIG. 3 stores data into and retrieves data from a flash memory 302. The flash memory may be embedded within the host, such as in the form of a solid state disk (SSD) drive installed in a personal computer. Alternatively, the memory 302 may be in the form of a flash memory card that is removably connected to the host through mating parts 304 and 306 of a mechanical and electrical connector as illustrated in FIG. 3. A flash memory configured for use as an internal or embedded SSD drive may look similar to the schematic of FIG. 3, with one difference being the location of the memory system 302 internal to the host. SSD drives may be in the form of discrete modules that are drop-in replacements for rotating magnetic disk drives.

Examples of commercially available removable flash memory cards include the CompactFlash (CF), the MultiMediaCard (MMC), Secure Digital (SD), miniSD, Memory Stick, SmartMedia, TransFlash, and microSD cards. Although each of these cards may have a unique mechanical and/or electrical interface according to its standardized specifications, the flash memory system included in each may be similar. These cards are all available from SanDisk Corporation, assignee of the present application. SanDisk also provides a line of flash drives under its Cruzer trademark, which are hand held memory systems in small packages that have a Universal Serial Bus (USB) plug for connecting with a host by plugging into the host's USB receptacle. Each of these memory cards and flash drives includes controllers that interface with the host and control operation of the flash memory within them.

Host systems that may use SSDs, memory cards and flash drives are many and varied. They include personal computers (PCs), such as desktop or laptop and other portable computers, tablet computers, cellular telephones, smartphones, personal digital assistants (PDAs), digital still cameras, digital movie cameras, and portable media players. For portable memory card applications, a host may include a built-in receptacle for one or more types of memory cards or flash drives, or a host may require adapters into which a memory card is plugged. The memory system may include its own memory controller and drivers but there may also be some memory-only systems that are instead controlled by software executed by the host to which the memory is connected. In some memory systems containing the controller, especially those embedded within a host, the memory, controller and drivers are often formed on a single integrated circuit chip.

The host system 300 of FIG. 3 may be viewed as having two major parts, insofar as the memory 302 is concerned, made up of a combination of circuitry and software. They are an applications portion 308 and a driver portion 310 that interfaces with the memory 302. As discussed, the memory system 302 may include an array of flash devices (e.g. flash storage modules 106) that are controlled by the host system 300 (e.g. host 102). In particular, the driver portion 310 may include a media management layer (“MML”) 104 for controlling the array of flash storage modules 106. The MML 104 may include drivers for controlling the FSMs 106. Functions from the flash management of the system controller 318 may be shifted to the host 300. In particular, the MML 104 may take over certain operations, such that the flash management 326 only handles low level operations. The low level operations may include real time NAND compensation, error detection, cell voltage tracking, flash page write/read/erase, error correction code (“ECC”), RAID, data encryption, flash error detection/handling, and/or data integrity protection. There may be a central processing unit (CPU) 312 implemented in circuitry and a host file system 314 implemented in hardware. In a PC, for example, the applications portion 308 may include a processor 312 running word processing, graphics, control or other popular application software. In a camera, cellular telephone or other host system 314 that is primarily dedicated to performing a single set of functions, the applications portion 308 includes the software that operates the camera to take and store pictures, the cellular telephone to make and receive calls, and the like.

The memory system 302 of FIG. 3 may include non-volatile memory, such as flash memory 316, and a system controller 318 that both interfaces with the host 300 to which the memory system 302 is connected for passing data back and forth and controls the memory 316. The flash memory 316 may include one or more NANDs as illustrated in FIG. 1. The system controller 318 may convert between logical addresses of data used by the host 300 and physical addresses of the flash memory 316 during data programming and reading. Functionally, the system controller 318 may include a front end 322 that interfaces with the host system, controller logic 324 for coordinating operation of the memory 316, low level flash management logic 326 for internal memory management operations such as garbage collection, and one or more flash interface modules (FIMs) 328 to provide a communication interface between the controller with the flash memory 316. The system controller 318 may be implemented on a single integrated circuit chip, such as an application specific integrated circuit (ASIC). A processor of the system controller 318 may be configured as a multi-thread processor capable of communicating via a memory interface having I/O ports for each memory bank in the flash memory 316.

FIG. 4 is a diagram illustrating operations performed by the host. The host operations 402 shown in FIG. 4 are exemplary operations performed by the MML 104 by the host 102. The host operations 402 may include operations that may have been previously performed by on the flash memory device itself, such as on an MML or flash management layer that is part of the flash memory. As described, the flash memory may maintain certain flash management operations, but the host operations 402 illustrated in FIG. 4 are performed at the host 102. In alternative embodiments, more or fewer operations may be performed by the host 102 and certain of these host operations 102 may be maintained on the flash memory management layer. The host operations 402 may generally be referred to as read/write controls and may include management of the firmware by the host.

Mapping 404 is an exemplary host operation 402 that may be part of the MML 104 at the host 102. In one embodiment, mapping 404 may be a main operation by the MML 104. The MML 104 may take the physical memory and translate it into a virtual system that allows for a mapping between virtual and physical addresses.

Wear leveling 406 is another exemplary host operation 402 that may be part of the MML 104 at the host 102. As part of the mapping function, the wear leveling 406 maps out the writing locations and ensures that the same location is not repeatedly written to more than others (i.e. worn out through disproportionate use). The data may be moved around, so that the memory is evenly worn out.

Data ordering 408 is another exemplary host operation 402 that may be part of the MML 104 at the host 102. For example, data ordering 408 may include how to combine the data, or how to efficiently use the physical structure of the NAND. Re-ordering or ordering the data allows for prioritizing. For example, a read function may be put ahead of a write depending on system needs/resources and this reordering is accomplished as a host operation.

Pre-fetch 410 is another exemplary host operation 402 that may be part of the MML 104 at the host 102. The pre-fetch may include a look ahead so that the host knows what information it wants next. This look ahead may be used to prepare the device to be ready for the next instruction or command.

Garbage collection 412 is another exemplary host operation 402 that may be part of the MML 104 at the host 102. Garbage collection is used to more efficiently store data by combining blocks of active data and deleting blocks with limited active data.

Block management 414 is another exemplary host operation 402 that may be part of the MML 104 at the host 102. Block management 414 may include the localized management of blocks. For example, block management may include maintenance of a bad block list, as well as keeping track of free blocks and used blocks. Block management may further include the control and usage of SLC and MLC blocks.

Data buffering 416 is another exemplary host operation 402 that may be part of the MML 104 at the host 102. Data buffering 416 may include the allocation of data to a RAM. For example, the host may have a large RAM which may be used for buffering. The MML may allocate the buffer to accumulate data, merge small chunk of data, or cache hot data.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a processor, memory device, computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A server system comprising:
an array of memory modules;
a host server having a processor configured for media management layer instructions for transmission to the array of memory, wherein the media management layer instructions comprise logical address to physical address mapping; and
a scalable interface hub coupled with the host server for providing communications between the host server and the array of memory, wherein the array of memory comprises flash storage modules that are managed by the host server through the media management layer instructions at the host server

2. The server system of claim 1 wherein the scalable interface hub comprises a Peripheral Component Interconnect Express (“PCIe”) hub.

3. The server system of claim 1 wherein each of the flash storage modules comprises a bridge for communicating with the host server through the scalable interface hub and for communicating with one or more NAND memory devices.

4. The server system of claim 3 wherein the bridge includes a controller that provides low-level controls for the NAND memory devices, while other controls and management operations are performed by the media management layer from the host server.

5. The server system of claim 4 wherein the low level controls include at least one of real time NAND compensation, error detection, cell voltage tracking, page write/read/erase, error correction code (“ECC”), data encryption, flash error detection/handling, or data integrity protection.

6. The server system of claim 1 wherein the media management layer comprises a flash transformation layer or a flash management layer.

7. The server system of claim 1 wherein the media management layer is implemented by one or more drivers stored at the host server.

8. The server system of claim 1 wherein the media management layer comprises operations for mapping, wear leveling, data ordering, pre-fetch, and/or garbage collection.

9. The server system of claim 1 wherein the server system comprises an Enterprise Server System.

10. A server system comprising:
a host with a memory management layer; and
an array of flash memory devices in communication with the host, each of the flash memory devices comprising:
a non-volatile storage having an array of memory blocks storing data;
a bridge interface for communicating with an interface hub that uses a scalable communication interface; and
a controller in communication with the non-volatile storage, wherein the controller is configured to:
perform low level operations for reading and writing data to the non-volatile storage;
wherein the memory management layer is configured to allow the host to manage the array of flash memory devices and perform memory management operations on behalf of the array of flash memory devices.

11. The server system of claim 10 wherein the low level controls include at least one of real time NAND compensation, error detection, or cell voltage tracking.

12. The server system of claim 10 wherein the memory management operations comprise at least one of mapping between logical and physical addresses, wear leveling, data ordering, pre-fetch, or garbage collection.

13. The server system of claim 10 wherein the scalable communication interface comprises Peripheral Component Interconnect Express (“PCIe”) and the interface hub comprises a PCIe interface hub.

14. An enterprise memory system comprising:
a host server computer that controls the enterprise memory system utilizing a processor for performing media management operations;
an array of flash storage modules controlled by the host server computer, each module of the array of flash storage modules comprising:
a non-volatile storage having an array of memory blocks storing data; and
a bridge configured to interface the host server computer through a scalable interface hub with the non-volatile storage and communicate low-level controls for the non-volatile storage within the module.

15. The enterprise memory system of claim 14 wherein the scalable interface hub comprises a Peripheral Component Interconnect Express (“PCIe”) interface hub.

16. The enterprise memory system of claim 14 wherein the bridge includes a controller that provides the low-level controls including at least one of real time NAND compensation, error detection, or cell voltage tracking.

17. The enterprise memory system of claim 14 wherein the non-volatile storage comprises one or more NAND memory devices.

18. The enterprise memory system of claim 14 wherein the host server computer comprises a media management layer or flash transformation layer with the processor for performing the media management operations.

19. The enterprise memory system of claim 18 wherein the media management operations comprise at least one of mapping between logical and physical addresses, wear leveling, data ordering, pre-fetch, or garbage collection.

20. The enterprise memory system of claim 14 wherein the low-level controls comprises at least one of page write/read/erase, real time NAND compensation, error detection, cell voltage tracking, error correction code (“ECC”), data encryption, flash error detection/handling, or data integrity protection.
